(19) United States
(12) Patent Application Publication
(10) Pub. No.: US 2007/0181375 A1
(43) Pub. Date: Aug. 9, 2007

(54) Elevator controller

(75) Inventor: Hiroshi Araki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Chiyoda-ku, Tokyo (JP)

(21) Appl. No.: 10/591,182

(22) PCT Filed: Mar. 2, 2004
(86) PCT No.: PCT/JP04/02542

§ 371 Date: Aug. 30, 2006

(51) Int. Cl. B66B 1/28

(52) U.S. Cl. 187/293

(57) ABSTRACT

An elevator control apparatus reducable in size by securing an installation space with ease, and which is excellent in noise immunity. A winch operates a car to perform an upward and downward movement, a motor generates a driving force for the winch, an inverter controls the motor to change its rotational speed in a variable manner, and an ECU controls the inverter. The winch, motor, inverter and ECU are integrally constructed with one another and installed as a drive control device. In addition, a traffic control device controls the traffic operation of the car by generating a traffic pattern corresponding to a destination floor from a current position of the car in response to a hall call or a car call. The traffic control device is separate from the drive control device.

### TECHNICAL FIELD

The present invention relates to an elevator control apparatus using an inverter, and in particular, to a novel installation construction that can achieve reduction in size and cost.

### BACKGROUND ART

In general, a traction elevator control apparatus using an inverter can be referred to, for example, in Japanese patent application laid-open No. H11-246137 (hereinafter called a “first patent document”), etc.

FIG. 9 and FIG. 10 are a block diagram and a circuit configuration diagram, respectively, showing an installation example of a general elevator control apparatus described as prior art in the above-mentioned first patent document.

In FIG. 9, in a machine room 1, there is installed a controller 2, a three-phase induction motor (hereinafter referred to simply as a “motor”) 3 adapted to be driven under the control of the controller 2, a speed reducer 4 for reducing the output number of revolutions per minute of the motor 3, a main sheave 5 connected with an output shaft of the speed reducer 4, and a deflection sheave 6.

The motor 3 and the speed reducer 4 are driven based on a control command from the controller 2, and the drive output of the motor 3 is transmitted through the speed reducer 4 to the main sheave 5.

A rope 7 is wrapped around the main sheave 5 and the deflection sheave 6. A car 8 is hung from one end of the rope 7, and a counter weight 9 is hung from the other end of the rope 7.

As a result, the car 8 is operated to vertically move in a hoistway G including a hall F of each service floor.

A hall call button 10 with an indicator is arranged in each hall F, and a hall call (operation signal) from each hall call button 10 is input to the controller 2. Similarly, a car call (operation signal) from a car call button (not shown) in the car 8 is also input to the controller 2.

FIG. 10 shows a circuit configuration in the controller 2, and in this case, the illustration of each hall F and the hoistway G is omitted.

In FIG. 10, the controller 2 in the machine room 1 is fed power from a three-phase commercial power supply 11 thereby to drive the motor 3.

The controller 2 includes a protective relay 12 inserted in a power supply line, an electromagnetic contactor 13 for controlling to open and close the power supply line, a noise filter 14 inserted in the power supply line, a three-phase rectifier 15, a smoothing capacitor 16 for smoothing a DC output from the rectifier 15, a three-phase inverter (hereinafter referred to simply as an “inverter”) 17 for converting a DC output of the smoothing capacitor 16 into a desired three-phase output, a reactor 18 inserted in an output line of the inverter 17, a regenerative semiconductor switching element 19 inserted in a regenerative line of the inverter 17, a regenerative resistor 20 connected in series to the regenerative semiconductor switching element 19, a flywheel diode 21 connected in parallel to the regenerative resistor 20, and an ECU 22 for controlling the electromagnetic contactor 13, the inverter 17, etc., based on various kinds of input signals.

In addition, the controller 2 includes a pulse generator 23 for detecting the rotational speed of the motor 3, and a brake 24 for braking the main sheave 5.

The protective relay 12, the electromagnetic contactor 13, the noise filter 14, the rectifier 15, and the smoothing capacitor 16 in the controller 2 together constitute a DC power supply part that converts the power supplied from the three-phase commercial power supply 11 into DC power.

In addition, the inverter 17 and the reactor 18 together constitute an AC drive part for converting the DC power into three-phase AC power thereby to drive the motor 3, and the regenerative semiconductor switching element 19, the regenerative resistor 20, and the flywheel diode 21 together constitute a regenerative part.

In the controller 2, the ECU 22, functioning as a control circuit, takes in a pulse signal generated from the pulse generator 23, a hall call from the hall call button 10, a car call from inside the car 8 and other various kinds of input signals, as detection signals, whereby it drives and controls the electromagnetic contactor 13, the inverter 17, the regenerative semiconductor switching element 19, the brake 24, etc.

Next, reference will be made to the operation of the general elevator control apparatus as shown in FIG. 9 and FIG. 10.

First of all, when the electromagnetic contactor 13 is turned on, the AC power supplied from the three-phase commercial power supply 11 is introduced into the noise filter 14 through the protective relay 12 and the electromagnetic contactor 13, and is then converted, after removal of noise components, into DC power by the rectifier 15 and the smoothing capacitor 16.

The DC power through the smoothing capacitor 16 is converted into three-phase AC power of a desired frequency voltage by means of the inverter 17, whereby the motor 3 is driven to operate through the reactor 18. The rotational output of the motor 3 is reduced in rotational speed as required by the speed reducer 4, and is then transmitted to the main sheave 5 to contribute to the vertical operation of the car 8.

On the other hand, when the hall call button 10 of a hall F or the car call button inside the car 8 is operated by a passenger during the vertical operation of the car 8, an operation signal (a hall call or a car call) is sent to the ECU 22.

As a result, the ECU 22 identifies the output signal from the hall call button 10 (or the car call button) or from the pulse generator 23, and controls the inverter 17, so that the motor 3 is driven to rotate in a forward direction or in a reverse direction, and the brake 24 is driven to operate, as required.

In addition, the ECU 22 controls the turning on and off of the regenerative semiconductor switching element 19 in a regenerative mode, so that regenerative energy from the motor 3 is consumed and absorbed by the regenerative resistor 20.

Here, note that there are cases where the noise filter 14 and the reactor 18 are used and not used.

In addition, in the case of a gearless system, the speed reducer 4 is not needed, and the regenerative control circuits 19 through 21 are not needed, either, so the system instead becomes such that the rectifier 15 is changed into a converter of the same construction as the inverter 17 so as to perform regeneration of the power supply.

Thus, in the general elevator control apparatus, the motor 3 is driven by the inverter 17 to operate the car 8.

At this time, as shown in FIG. 10, a drive circuit including the individual circuit elements 15 through 17 is integrally constructed with the ECU 22 inside the controller 2 that controls the motor 3. On the other hand, the motor 3 for driving the car 8 to operate or move in the vertical direction is connected to an output side of the controller 2 through a power cable.

In addition, the controller 2 of the general traction elevator control apparatus is housed in the machine room 1 installed on the rooftop in a building, as shown in FIG. 9.

However, in recent medium and low rise buildings, it is required to install an elevator system without providing the machine room 1 due to the right to sunshine, environmental problems, or the constraints of the building side.

For example, as an elevator system without the provision of the machine room 1, there have been proposed one using a linear motor, and another one with a motor of a special construction being arranged in a hoistway so as to drive a car to move in the upward and downward direction.

In addition, there has also been a drum elevator system which makes it unnecessary to employ the machine room 1 by arranging a winch in a pit, as in the case of a home elevator system of a small capacity.

However, in any of the special elevator systems, it is constructed such that an inverter control device for driving a motor is separately arranged from a winch and a motor.

On the other hand, in the above-mentioned first patent document, as shown in FIG. 11 for example, there is described an elevator control apparatus in which those portions except for elevator parts such as a car 8, a counter weight 9, etc., are separately constructed into a drive unit 41 and a control unit 42.

In FIG. 11, like parts or elements as those described above (see FIG. 10) are identified by the same symbols.

In this case, the drive unit 41 constructs a drive circuit part comprising component elements 13 through 21 and a motor part comprising component elements 3 through 5, 23 and 24 into an integral unit. Also, the control unit 42 constructs the protective relay 12 and the ECU 22 into an integral unit. The construction other than the above is similar to that of FIG. 10.

As described above, in the general elevator control apparatus as shown in FIG. 9 and FIG. 10, the motor part including the motor 3 and the main sheave 5 (winch) and a control circuit part including the inverter 17 and the ECU 22 are arranged separately from each other, so there arise problems as described in the following items (1) though (3).

(1) The motor part and the control circuit part, which require a large space, are constructed separately from each other, so the mounting efficiency of the elevator control apparatus is poor.

(2) The control circuit part includes the inverter 17 with a large amount of heat generated thereby, and hence it is required to install a cooling part, but if the apparatus is to be reduced in size, it will become difficult to install such a cooling part.

(3) Since the motor part and the control circuit part are arranged separately from each other, main circuit wiring for connecting between both of them is needed, but in this case, the main circuit wiring acts as a noise source, so the amount of noise generated increases.

In addition, in case where the AC drive part including the inverter 17 is integrated with the motor part to construct the drive unit 41, which is separated from the control unit 42 including the ECU 22, as shown in FIG. 11, the influence of superposition of noise on signal wiring connecting between the drive unit 41 and the control unit 42 similarly occurs. Accordingly, it becomes necessary to take an appropriate measure for noise reduction, thus making it difficult to achieve reduction in size and cost.

### DISCLOSURE OF THE INVENTION

The present invention has been made in view of the above circumstances, and has for its object to provide an elevator control apparatus which is capable of attaining reduction in size while securing an installation space with ease, and which is excellent in noise immunity.

To solve the above-mentioned problems, according to the present invention, a winch for operating a car to perform an upward and downward movement, a motor for generating a driving force to the winch, an inverter for controlling the motor so as to change its rotational speed in a variable manner, and an ECU for controlling the inverter are integrally constructed with one another so as to be installed as a drive control device.

In addition, a traffic control device for controlling or managing the traffic operation of the car by generating a traffic pattern corresponding to a destination floor from a current position of the car in response to a hall call or a car call is installed while being divided from the drive control device.

Moreover, the drive control device is installed in a hoistway for the car, and the traffic control device is installed at a location that is accessible by an operator (i.e., in a hall, in a wall of a hall, in an inner wall of the hoistway, or in the car).

Further, by integrally constructing the winch, the motor, the inverter and the ECU by means of resin molding, the process of integration is made simple and easy.

Furthermore, cooling fins made of metal for cooling heating elements (e.g., the motor and the inverter) are formed integrally therewith by resin molding, so that the heating elements can be cooled in an integrated manner, thereby making it possible to further reduce the size and improve the cooling performance.

In addition, a signal transmission part between the drive control device and the traffic control device can be achieved by serial communication, optical communication, radio communication, or power line multiplex communication.

Further, by using, as the inverter, a power conversion device of a matrix converter circuit type, which makes the use of an electrolytic capacitor unnecessary, an increased life span is achieved.

### BRIEF DESCRIPTION OF THE DRAWINGS

FIG. 1 is a circuit diagram showing an elevator control apparatus according to a first embodiment of the present invention.

FIG. 2 is a block diagram showing an installation example of an elevator control apparatus according to the first embodiment of the present invention, wherein there is illustrated a state in which a drive control device is installed in a hoistway, and a traffic control device is installed in a hall.

FIG. 3 is a block diagram showing an installation example of an elevator control apparatus according to a second embodiment of the present invention, wherein there is illustrated an example in which the present invention is applied to a drum elevator system.

FIG. 4 is a block diagram showing an installation example of an elevator control apparatus according to a third embodiment of the present invention, wherein there is illustrated an example in which the present invention is applied to a linear motor elevator system.

FIG. 5 is a block diagram showing an installation example of drive control devices of an elevator control apparatus according to a fourth embodiment of the present invention, wherein there is illustrated an example in which the present invention is applied to the drive control devices that are arranged in parallel to each other.

FIG. 6 is a block diagram showing an elevator control apparatus according to a fifth embodiment of the present invention, wherein there is illustrated an example in which the present invention is applied to drive control devices that drive a plurality of cars, respectively.

FIG. 7 is a vertical cross sectional view showing a drive control device of an elevator control apparatus according to a sixth embodiment of the present invention.

FIG. 8 is a block diagram showing an elevator control apparatus according to a seventh embodiment of the present invention, wherein there is illustrated an example that uses a power conversion device of a matrix converter circuit type as an inverter.

FIG. 9 is a block diagram showing an installation example of a conventional elevator control apparatus.

FIG. 10 is a circuit diagram showing the overall construction of the conventional elevator control apparatus.

FIG. 11 is a circuit diagram showing an constructional example of another conventional elevator control apparatus.

### BEST MODE FOR CARRYING OUT THE INVENTION

### EMBODIMENT 1

Hereinafter, a first embodiment of the present invention will be described while referring to the accompanying drawings.

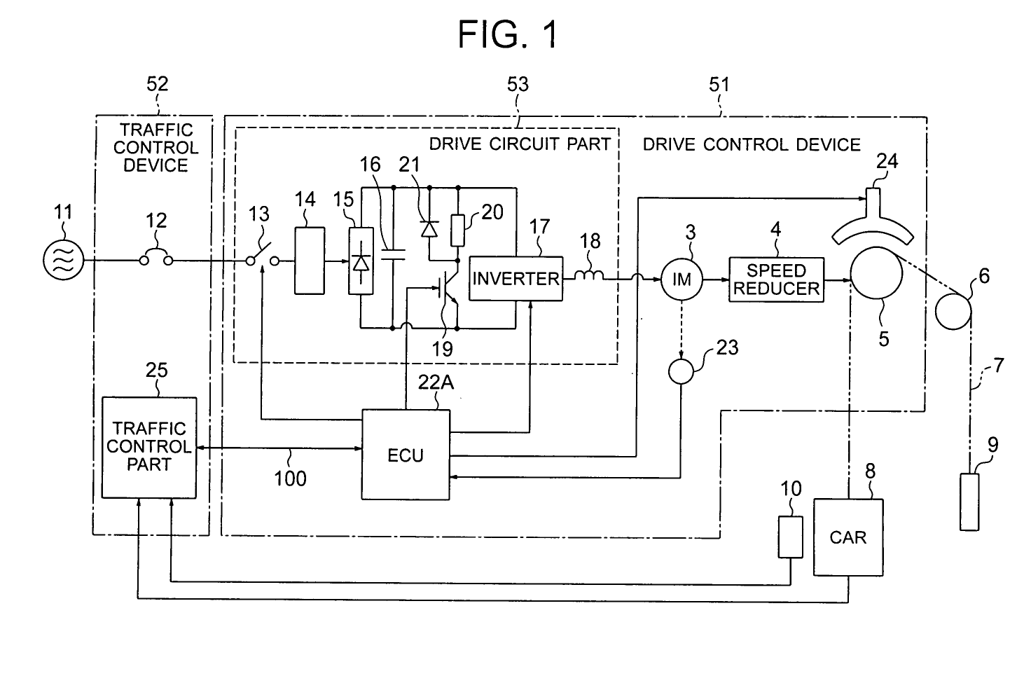

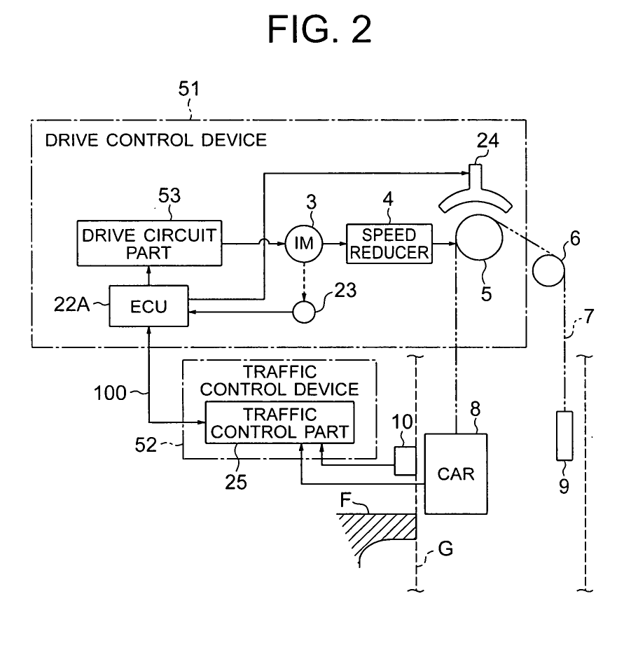

FIG. 1 is a block diagram that shows an elevator control apparatus according to the first embodiment of the present invention, and FIG. 2 is a block diagram that shows an installation example of the elevator control apparatus according to the first embodiment of the present invention.

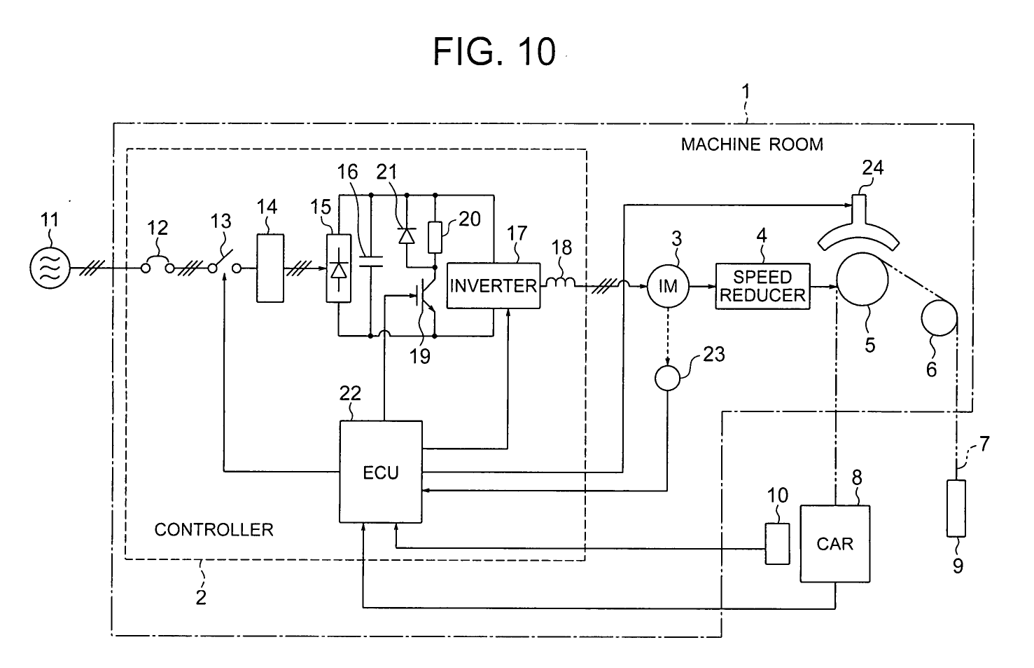

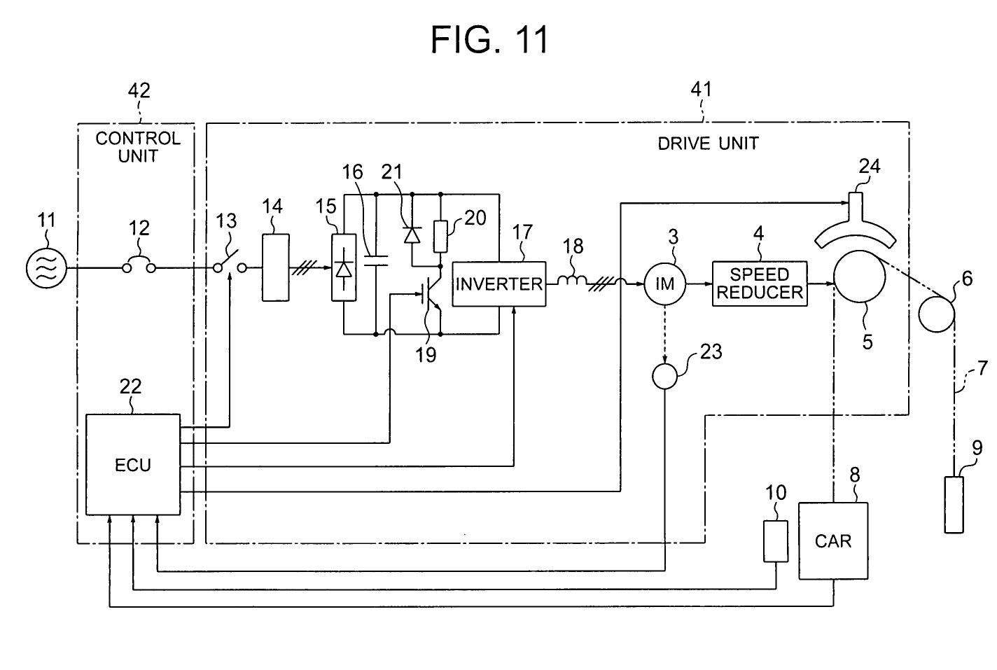

In FIG. 1 and FIG. 2, the same parts or components as those described above (see FIG. 10 and FIG. 11) are identified by the same symbols or by the same symbols with “A” affixed to their ends, while omitting a detailed explanation thereof.

In FIG. 1 and FIG. 2, what is different from FIG. 11 is that those parts excluding a car 8 and a counter weight 9 are separately constructed into a drive control device 51 and a traffic control device 52, which are mutually connected to each other through a signal transmission part 100.

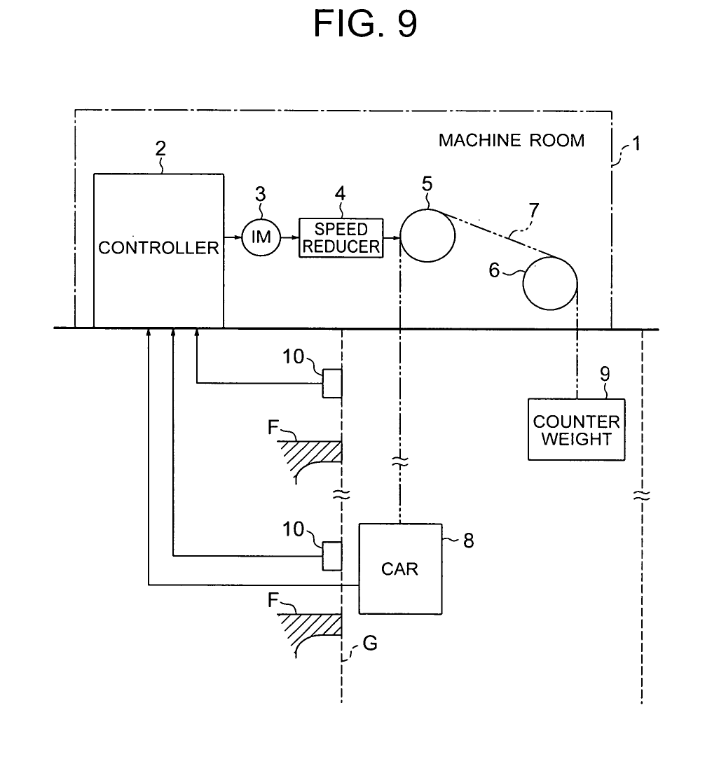

In addition, the overall construction of the first embodiment of the present invention is as shown in FIG. 9 excepting that a machine room 1 can be omitted.

In this case, the drive control device 51 is constructed by integrating a drive circuit part 53 including the above-mentioned component elements 13 through 21, an ECU 22A, and a motor part 3 through 5, 23 and 24 with one another.

Also, the traffic control device 52 is constructed by integrating a protective relay 12 and a traffic control part 25 with each other.

When an operation signal (a hall call or a car call) of a hall call button 10 in the hall F or a car call button in the car 8 is input, the traffic control part 25 in the traffic control device 52 performs traffic control such as stopping the travel of the car 8.

The traffic control part 25 separates a traffic control function from the ECU 22 of the conventional apparatus (see FIG. 10).

The traffic control part 25 is arranged in a place that is easily accessible by a maintenance worker or operator, as will be described later.

Although the traffic control part 25 is integrally constructed with the protective relay 12, it may be separately constructed from the protective relay 12 without the occurrence of any particular impediment.

Further, if a general-purpose personal computer is used as the traffic control part 25, an appropriate one can be selected based on the performance of a personal computer generally sold in the market in accordance with the required performance of traffic control, so reduction in cost can be achieved in accordance with the required performance.

The control operation of the elevator control apparatus shown in FIGS. 1 and 2 is substantially similar to the case of the above-mentioned conventional apparatus.

That is, when the hall call button 10 of the hall F or the car call button inside the car 8 is operated during the vertical operation of the car 8, an operation signal (a hall call or a car call) is sent to the traffic control part 25.

Based on this signal, the traffic control part 25 determines a destination floor and stop floors of the car 8 and sends the response signal to the ECU 22A, and the ECU 22A outputs a control signal.

Hereinafter, the drive circuit part 53 and the motor part 3 through 5, 23 and 24 are driven and controlled by the control signal from the ECU 22A, whereby the car 8 performs a desired vertical operation.

At this time, the drive control device 51 is installed in a hoistway G, as shown in FIG. 2.

In addition, though the traffic control device 52 is installed in the hall F as an example, it may instead be installed in a location that is accessible by an operator, i.e., in the hall F, in the wall of the hall F, in the inner wall of the hoistway G, or in the car 8.

As a result, there is no need to install the drive control device 51 and the traffic control device 52 in the machine room 1 (see FIG. 9), so the machine room 1 can be omitted.

Here, note that the signal transmission part 100 between the ECU 22A and the traffic control part 25 can be achieved by serial communication, optical communication, radio communication, power line multiplex communication or the like.

According to the installation construction shown in FIG. 2, the drive circuit part 53 and the motor part 3 through 5, 23 and 24 are integrated with each other to form the drive control device 51. As a result, the drive control device 51 can be received in the hoistway G, so an appropriate portion of the hoistway G can be effectively used for this purpose without securing a special space.

In addition, by integrally constructing the drive circuit part 53 and the motor part 3 through 5, 23 and 24 with each other, the distance between the inverter 17 and the motor 3 is made the shortest, so the noise generated from connection lines between these parts can be suppressed.

Also, by integrating the drive circuit section 53 and the motor part 3-5, 23 and 24, which become sources of noise, with each other to gather them together, a countermeasure for noise can be easily taken, so the influence of noise on the traffic control device 52 can be reduced.

Further, with the above-mentioned integration construction, not only the noise problem is eliminated but also countermeasures for the sources of heat generation become easy. As a result, the amount of heat generated by the traffic control device 52 can be easily suppressed, thus making it possible to contribute to further reduction in size thereof.

On the other hand, the traffic control part 25, being substantially composed of the traffic control device 52 alone, can be reduced in size as compared with the case of a conventional one, so the degree of freedom of the installation site increases, thus making it possible to meet various layout requirements.

### EMBODIMENT 2

Although in the above-mentioned first embodiment (FIG. 1 and FIG. 2), an explanation has been given to the case where the present invention is applied to an elevator apparatus that uses the deflection sheave 6 and the counter weight 9, it is of course needless to say that the installation construction of a similar elevator control apparatus can also be applied to a drum elevator system, for example.

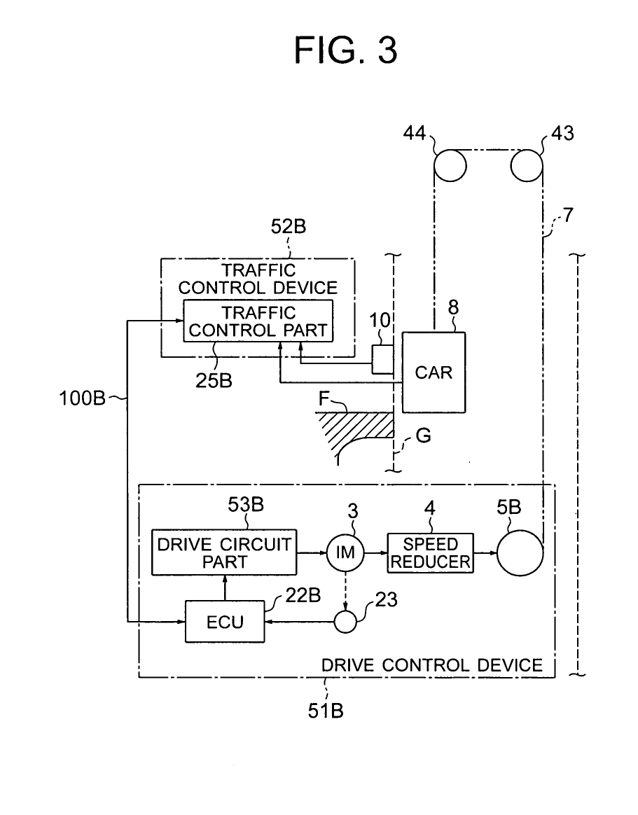

FIG. 3 is a block diagram that shows an installation example of an elevator control apparatus according to a second embodiment of the present invention, wherein there is illustrated a case where the present invention is applied to a drum elevator system.

In FIG. 3, the same parts or components as those described above (see FIG. 1 and FIG. 2) are identified by the same symbols or by the same symbols with “B” affixed to their ends, while omitting a detailed explanation thereof.

In this case, a drive control device 51B is installed in an appropriate space of a lower portion in the hoistway G, and is provided with a drum main sheave 5B.

In addition, a traffic control device 52B is installed in the hall F, as stated above.

On the other hand, a rope 7 is wrapped around a plurality of (here, a pair of) sheaves 43, 44 that are installed on the top of the hoistway G (at locations higher than a hall F of the top or uppermost floor in the hoistway G). The individual sheaves 43, 44 are installed at the same height at a predetermined interval.

The rope 7 has one end side thereof wound up around the main sheave 5B of the drive control device 51B, with a car 8 being hung from the other end side of the rope 7.

An ECU 22B in the drive control device 51B is connected for mutual communication to a traffic control part 25B in the traffic control device 52B through a signal transmission part 100B.

Thus, operational effects equivalent to those as stated above are achieved even in case where the present invention is applied to the drum elevator system.

### EMBODIMENT 3

In addition, although in the above-mentioned second embodiment (FIG. 3), reference has been made to the case where the present invention is applied to the drum elevator system, the invention can also applied to a linear motor elevator system, for example.

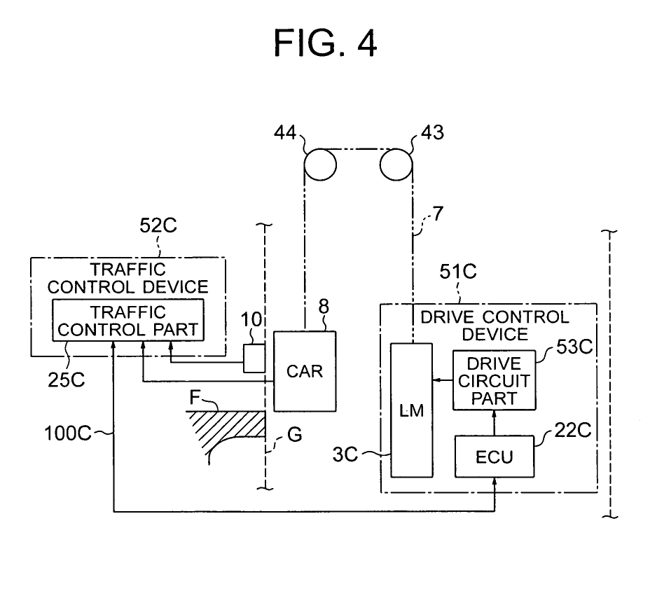

FIG. 4 is a block diagram that shows an installation example of an elevator control apparatus according to a third embodiment of the present invention, wherein there is illustrated a case where the present invention is applied to a linear motor elevator system.

In FIG. 4, the same parts or components as those described above (see FIG. 1 through FIG. 3) are identified by the same symbols or by the same symbols with “C” affixed to their ends, while omitting a detailed explanation thereof.

In this case, a drive control device 51C is installed in the hoistway G, and is provided with a linear motor 3C including a counterweight (not shown), a drive circuit part 53C for driving the linear motor 3C, and an ECU 22C.

In addition, a traffic control device 52C is installed in the hall F, as stated above.

The drive control device 51 including the linear motor 3C is connected with one end side of the rope 7 extending downward from the one sheave 43, and the car 8 is hung at the other end side of the rope 7 extending downward from the other sheave 44.

The ECU 22C in the drive control device 51C is connected for mutual communication to a traffic control part 25C in the traffic control device 52C through a signal transmission part 100C.

Thus, operational effects equivalent to those as stated above are achieved even in case where the present invention is applied to the linear motor elevator system.

### EMBODIMENT 4

Although in the above-mentioned first through third embodiments, reference has been made to the case where a single traffic control device is applied to one drive control device, it is needless to say that a single traffic control device can be applied to a plurality of drive control devices.

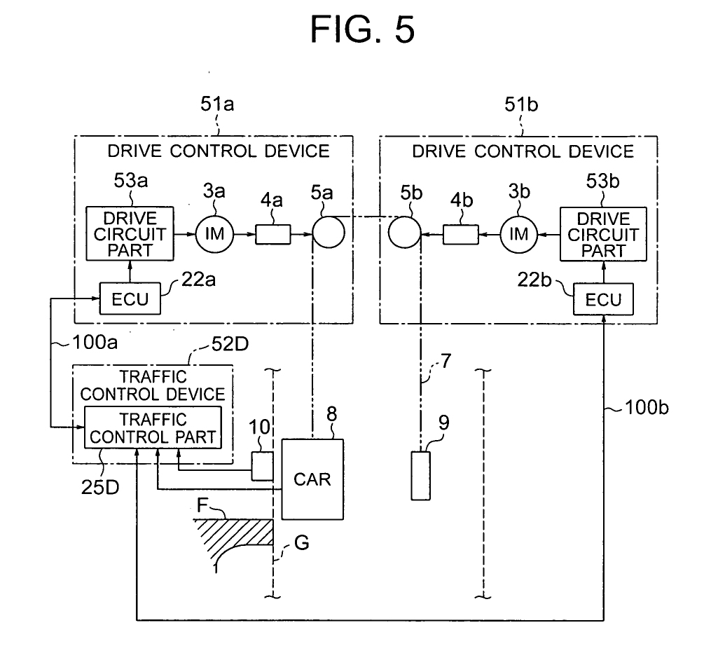

FIG. 5 is a block diagram that shows an installation example of drive control devices of an elevator control apparatus according to a fourth embodiment of the present invention, wherein there is illustrated a case where a single traffic control device 52D is applied to a plurality of (here, two) drive control devices 51a, 5b.

In FIG. 5, the same parts or components as those described above (see FIG. 1 through FIG. 4) are identified by the same symbols or by the same symbols with “D” affixed to their ends, while omitting a detailed explanation thereof.

In addition, the two drive control devices 51a, 51b are provided with component elements, similar to those as stated above(see FIG. 2), which are identified by the same symbols with “a” and “b” affixed to their ends, respectively, while omitting a detailed explanation thereof.

In this case, one traffic control device 52D is connected to the individual drive control devices 51a, 51b through signal transmission parts 100a, 100b, respectively, so that it controls ECUs 22a, 22b in the individual drive control devices 51a, 51b.

The individual drive control devices 51a, 51b are arranged in such a manner that main sheaves 5a, 5b are disposed on horizontal lines of the same height, respectively, in opposition to each other at an upper portion of the hoistway G.

A rope 7 is wrapped around the main sheaves 5a, 5b, and a counter weight 9 is hung at one end side of the rope 7, and a car 8 is hung at the other end side of the rope 7.

The traffic control device 52D controls the individual drive control devices 51a, 51b at the same time, so that the main sheaves 5a, 5b are driven to rotate in a forward or reverse direction thereby to move the car 8 in an upward or downward direction.

Thus, the plurality of control devices 51a, 51b for parallel driving can be controlled by the use of the single traffic control part 25D without any trouble. Accordingly, it is needless to say that operational effects equivalent to those as stated above can be obtained in this case, too.

Also, in this case, a demand for increasing the capacity of the drive control devices in accordance with the increasing load of the car 8 can be met by increasing the number of drive control devices.

Moreover, the drive control devices can be arranged in a distributed manner, so the degree of freedom of the installation space can be improved.

Further, the capacity of the drive control devices can be increased without changing the specification of each drive control device, the specifications for the drive control devices can be easily standardized.

### EMBODIMENT 5

Although in the above-mentioned fourth embodiment (FIG. 5), reference has been made to the case where the single traffic control device is applied to the plurality of drive control devices, a single traffic control device can be applied to individual drive control devices for driving a plurality of cars, respectively.

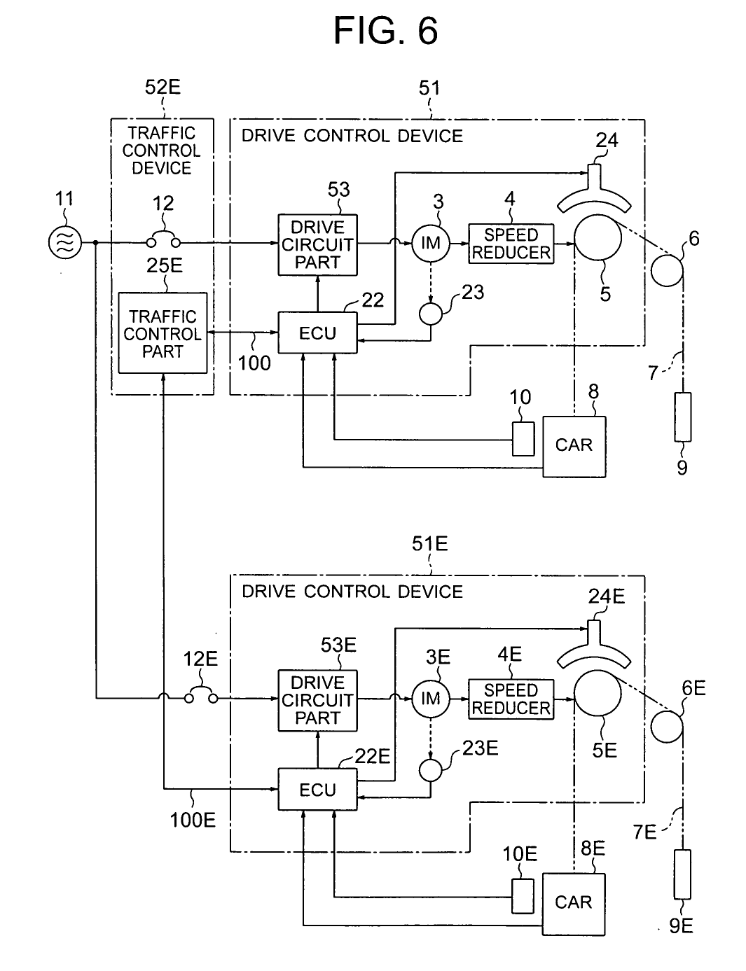

FIG. 6 is a block diagram that shows an installation example of an elevator control apparatus according to a fifth embodiment of the present invention, wherein there is illustrated a case where a single traffic control device 52E is applied to a plurality of (here, two) drive control devices 51, 51E.

In FIG. 6, the same parts or components as those described above (see FIG. 1 through FIG. 5) are identified by the same symbols or by the same symbols with “E” affixed to their ends, while omitting a detailed explanation thereof.

In this case, a traffic control part 25E in a traffic control device 52E is connected through signal transmission parts 100, 100E for mutual communication to individual ECUs 22, 22E in drive control devices 51, 51E, respectively, for individually driving cars 8, 8E.

As a result, the individual drive control devices 51, 51E can control the two cars 8, 8E individually and separately under the centralized control of the single traffic control device 52E.

Accordingly, in this case, too, operational effects equivalent to those as stated above can be obtained.

### EMBODIMENT 6

Although in the above-mentioned first through fifth embodiments, no reference has been made to a specific mounting structure for integrating drive control devices, they may be integrally constructed with one another by resin molding, for example.

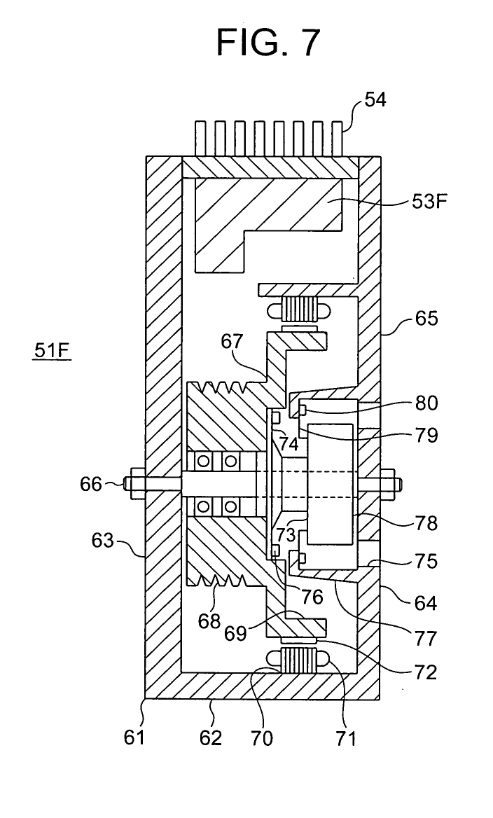

FIG. 7 is a vertical cross sectional view that shows the mounting structure of a drive control device 51F of an elevator control apparatus according to a sixth embodiment of the present invention.

In FIG. 7, it is assumed that a drive circuit part 53F is constructed by integrating the above-mentioned component elements 13 through 21 and ECU 22 (see FIG. 1) with one another.

In addition, other component elements 67 through 80 in a housing 61 correspond to the motor part 3 through 5 in FIG. 1.

Cooling fins 54 made of metal are formed on an outer end face of the drive circuit part 53F, and the cooling fins 54 serve to cool an inverter in the drive circuit part 53F and a motor 70 in the housing 61 (corresponding to the motor 3 in FIG. 1).

The housing 61 is provided with, in addition to the cooling fins 54, a base 62 that is located at an end face of the housing disposed at a side opposite to the cooling fins 54, a support plate 63 that is arranged at a one side end portion of the base 62, a side plate 64 that is arranged at the other side end portion of the base 62 in an opposed relation to and apart from the support plate 63, and a recess 65 that is formed in the side plate 64 with its bottom surface arranged in opposition to the support plate 63. The base 62, the support plate 63 and the side plate 64 are integrally constructed with the housing 61 by means of resin molding.

A support shaft 66 is arranged between and supported by the support plate 63 and the side plate 64.

A rotating member 67 is rotatably mounted on the support shaft 66, and a drive rope race 68 is formed on an outer peripheral surface of the rotating member 67 at a side near the support plate 63. In addition, a portion of the outer peripheral surface of the rotating member 67 near the side plate 64 is fitted in the recess 65 of the side plate 64 with a gap formed therebetween, and a concave portion 69 is formed in an end face of the rotating member 67 at a side near the side plate 64.

The motor 70 is composed of a stator 71 and a permanent magnet 72, and the stator 71 is arranged on an inner peripheral surface of the recess 65 of the side plate 64 opposing the outer peripheral surface of the rotating member 67. Also, the permanent magnet 72 is arranged on the outer peripheral surface of the rotating member 67 in opposition to the stator 71.

An encoder 73 (corresponding to the pulse generator 23 in FIG. 1) is arranged in the concave portion 69 of the rotating member 67, and the encoder 73 has a rotational side mounting plate 74 arranged on a bottom surface of the concave portion 69 of the rotating member 67.

Operation holes 75 are formed in the side plate 64 in such a manner that they are arranged around the support shaft 66.

Mounting screws 76 are arranged in opposition to the operation holes 75, and threaded into the bottom of the concave portion 69 of the rotating member 67.

The rotational side mounting plate 74 is coupled to the bottom surface of the concave portion 69 of the rotating member 67 by means of the mounting screws 76.

A mounting arm 77 is protruded from the side plate 64 toward the encoder 73 so as to enclose an outer peripheral surface of a fixed side housing 78 of the encoder 73. In addition, the mounting arm 77 has a projection end arranged at a position protruded toward the support plate 63 from an end face of the fixed side housing 78 of the encoder 73 at a side near the support plate 63.

A mounting leaf spring 79 has one end side thereof connected with an end face of the fixed side housing 78 of the encoder 73 at a side near the support plate 63, and the other end side thereof coupled to the mounting arm 77 by mounting screws 80.

The mounting screws 80 are arranged in opposition to the operation holes 75 formed in the side plate 64, and are threaded into the mounting arm 77.

The motor part including a winch for driving the car 8 to move in the vertical direction is constructed as stated above, and when the motor 70 is energized, the rotating member 67 is caused to rotate, whereby a main rope (not shown) of an elevator, which is wrapped around the drive rope race 68, is driven to move.

Also, the encoder 73 is rotated in accordance with the rotation of the rotating member 67, whereby the rotational speed of the rotating member 67, i.e., the vertical moving speed of the elevator, etc., is detected by the encoder 73.

Thus, the drive control device 51F can be integrally constructed with ease by using resin molding, as shown in FIG. 7.

### EMBODIMENT 7

Although in the above-mentioned first through sixth embodiments, the inverter requiring an electrolytic capacitor is used for the drive circuit part of the motor, a power conversion device of a matrix converter circuit type, which does not require an electrolytic capacitor, may be used as the inverter.

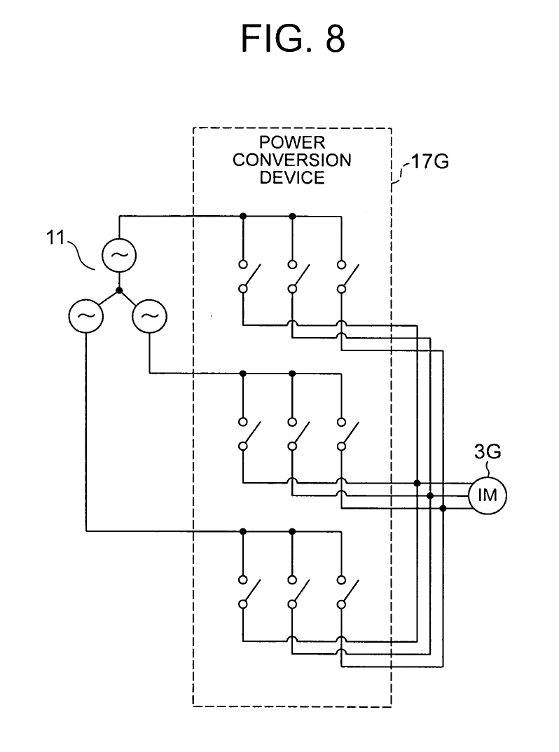

FIG. 8 is a block diagram showing a power conversion device in an elevator control apparatus according to a seventh embodiment of the present invention, wherein there is illustrated a case using the power conversion device of a matrix converter circuit type as an inverter.

In FIG. 8, an illustration of the same or like construction as described above is omitted.

In general, an electrolytic capacitor is mounted at a location near a heating element of an inverter, and hence has a short life (about 5 years), but in this case, such an electrolytic capacitor is made unnecessary by using a power conversion device 17G of a matrix converter circuit type. Accordingly, an increase in the life span thereof can be achieved.

Also, it is needless to say that in addition to this, operational effects equivalent to those as stated above can be obtained.

1-11. (canceled)

12. An elevator control apparatus comprising:
a winch for driving a car to move upward and downward;
an electric motor that generates a driving force for said winch;
an inverter that controls said electric motor so as to variably change its speed; and
an ECU that controls said inverter;
wherein said winch, said electric motor, said inverter, and said ECU together constitute a drive control device for said car, and are installed while being integrated with one another.

13. The elevator control apparatus as set forth in claim 12, further comprising:
a hall call button that is installed in a hall and generates, when operated, a hall call;
a car call button that is installed in said car and generates, when operated, a hall call; and
a traffic control device that controls the operation of said car by generating a traffic pattern from a current position of said car to a destination floor in response to said hall call or said car call;
wherein said traffic control device is installed while being divided from said drive control device.

14. The elevator control apparatus as set forth in claim 13, wherein:
said drive control device is installed in a hoistway for said car;
said traffic control device is installed in a position accessible by an operator; and
the installation location of said traffic control device includes said hall, the inside of a wall of said hall, and a wall in said hoistway.

15. The elevator control apparatus as set forth in claim 13, wherein:
said drive control device is installed in a hoistway for said car; and
said traffic control device is installed in said car.

16. The elevator control apparatus as set forth in claim 13, further comprising:
a signal transmission part that is arranged between said drive control device and said traffic control device;
wherein said signal transmission part uses serial communication, optical communication, radio communication or power line multiplex communication.

17. The elevator control apparatus as set forth in claim 12, wherein:
said drive control device is integrally constructed by resin molding.

18. The elevator control apparatus as set forth in claim 17, further comprising:
cooling fins that are made of metal and serve to cool said electric motor and said inverter.

19. The elevator control apparatus as set forth in claim 12, wherein:
said inverter comprises a power conversion device of a matrix converter circuit type; and
said drive control device is integrally constructed by using said power conversion device.

20. The elevator control apparatus as set forth in claim 13, wherein:
said traffic control device comprises a general-purpose personal computer.

21. The elevator control apparatus as set forth in claim 13, wherein:
said drive control device comprises a plurality of drive control devices for individually controlling a plurality of cars;
said plurality of drive control devices are each integrally constructed individually;
said traffic control device comprises a single traffic control device that performs traffic control of said plurality of drive control devices; and
said single traffic control device centrally controls said plurality of cars.

22. The elevator control apparatus as set forth in claim 21, wherein:
said plurality of drive control devices respectively include individual main sheaves, and an individual rope wrapped around said main sheaves; and
a counter weight is hung at one end side of said rope, and
said car is hung at the other end side of said rope.
